(19) United States
(12) Patent Application Publication
(10) Pub. No.: US 2015/0233779 A1
(43) Pub. Date: Aug. 20, 2015

(54) GLOVES WITH PRESSURE SENSORS

(71) Applicant: WALTOP INTERNATIONAL CORPORATION, Hsinchu City (TW)

(72) Inventors: DANIEL CHEN, Hsinchu City (TW); CHUNG-FUU MAO, Hsinchu City (TW)

(73) Assignee: WALTOP INTERNATIONAL CORPORATION, Hsinchu City (TW)

(21) Appl. No.: 14/270,651

(22) Filed: May 6, 2014

(30) Foreign Application Priority Data
Feb. 18, 2014 (TW) 103105366

(51) Int. Cl. G01L 1/22; G01C 19/04; G01P 15/00; G01L 5/00

(52) U.S. Cl. CPC G01L 1/22; G01L 5/0028; G01C 19/04; G01P 15/00

(57) ABSTRACT

Gloves with pressure sensors are disclosed. The gloves comprise a microprocessor, an accelerometer, a plurality of pressure sensors, a gyro sensor and a power source to detect pressure forces of fingers and postures and motions of palms of a user.

### BACKGROUND OF THE INVENTION

1. Field of the Invention

The present invention generally relates to electronic gloves, and more particularly to gloves with pressure sensors.

2. Description of the Related Art

There are many types of electronic gloves, most applications of the electronic gloves relate to simulations of playing electronic music and electronic knocking motion. In the application of simulation of playing music, electronic gloves can be used to simulate playing a piano which simulates statuses of keys being pressed through sensing motions of fingers and generates corresponding tones according to the statuses of keys being pressed. In addition to simulate playing a piano, electronic gloves can be used to simulate knocking musical instruments such as knocking a drum.

In addition to simulate playing a piano and knocking musical instruments, electronic gloves can be used to simulate keyboard input which simulates statuses of keys being pressed through sensing motions of fingers to input data. Electric gloves can also be used as input devices for computer games or video games, game actions are simulated according to palm motions.

In the applications of electronic gloves mentioned above, either simulations of playing electronic music or electronic knocking motion, or computer keyboard input, or as input devices for computer games or video games, none has function of detecting forces of user's fingers. Thus the present invention provides gloves with pressure sensors to increase functions and flexibility of applications of electronic gloves through simulating and sensing force strengths of user's fingers and motion and gesture of user's palms.

### SUMMARY OF THE INVENTION

One object of the invention is to provide a pair of gloves with pressure sensors comprising a microprocessor, an accelerometer, a plurality of pressure sensors, a gyro sensor and a power source. The accelerometer detects accelerations of the gloves and generates acceleration signals and then transmits the acceleration signals to the microprocessor. Each the pressure sensor is configured to be located on a contact surface of each finger of the gloves to detect forces applied upon the contact surface of each the finger and to generate pressure value signals and transmit the pressure value signals to the microprocessor. The gyro sensor detects angles, postures and motions of the gloves to generate posture signals and transmit the posture signals to the microprocessor. The power source provides the gloves with a power.

In one embodiment of the invention, the invention provides a finger ring apparatus with pressure sensors comprising a wristband and a plurality of finger rings. Each finger ring has a pressure sensor while a microprocessor, an accelerometer, a gyro sensor, and a power source are on the wristband.

### BRIEF DESCRIPTION OF THE DRAWINGS

FIG. 1 shows a block diagram of a system of gloves with pressure sensors according to one embodiment of the invention.

FIG. 2A and FIG. 2B show a glove with pressure sensors and a pressure sensor respectively according embodiments of the invention.

FIG. 3 shows a finger ring apparatus with pressure sensors according embodiments of the invention.

### DETAILED DESCRIPTION

Embodiment of this invention will be described in detail below. However, in addition to as described below, and this invention can be broadly implemented in the other cases the purpose and scope of this invention is not affected by the application of qualified, claim after its prevail. Furthermore, to provide a description more clear and easier to understand the invention, the pieces within the schema and not in accordance with their relative size of drawing, compared to certain dimensions to other scales have been exaggerated; details not related nor completely drawn in part in order to schematic simplicity.

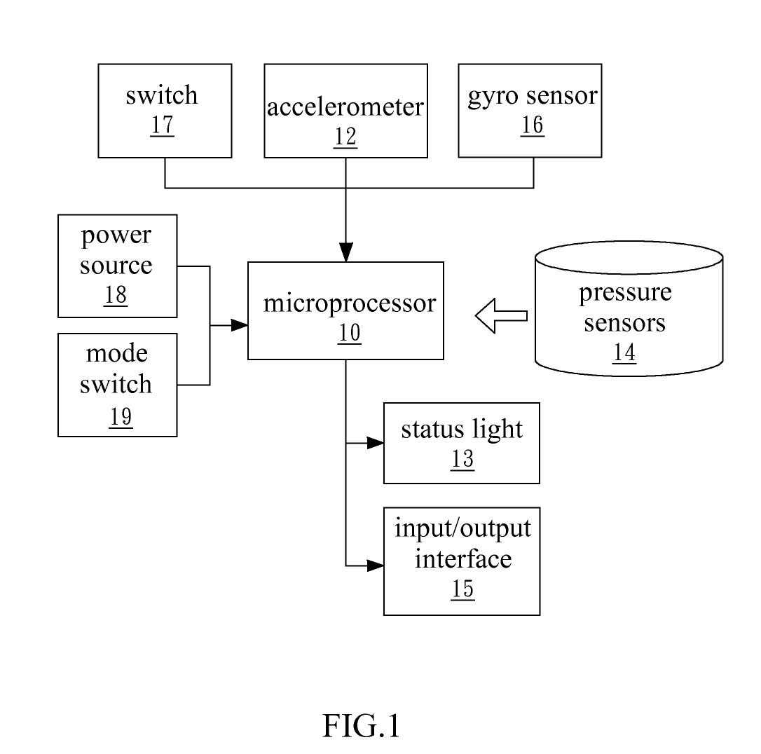

FIG. 1 shows a block diagram of a system of gloves with pressure sensors according to one embodiment of the invention. The system of gloves with pressure sensors comprises a microprocessor 10, an accelerometer 12, ten pressure sensors 14, a gyro sensor 16 and a power source 18. The system of gloves with pressure sensors further comprises a status light 13, an input/output interface 15, a switch 17 and a mode switch 19.

The ten pressure sensors 14 are configured to be located on ten fingers of two gloves respectively. More specifically, each pressure sensor 14 is configured to be located on the contact surface of each finger. The pressure sensor 14 comprises a flexible thin film resistor or a pressure/force sensitive sensor.

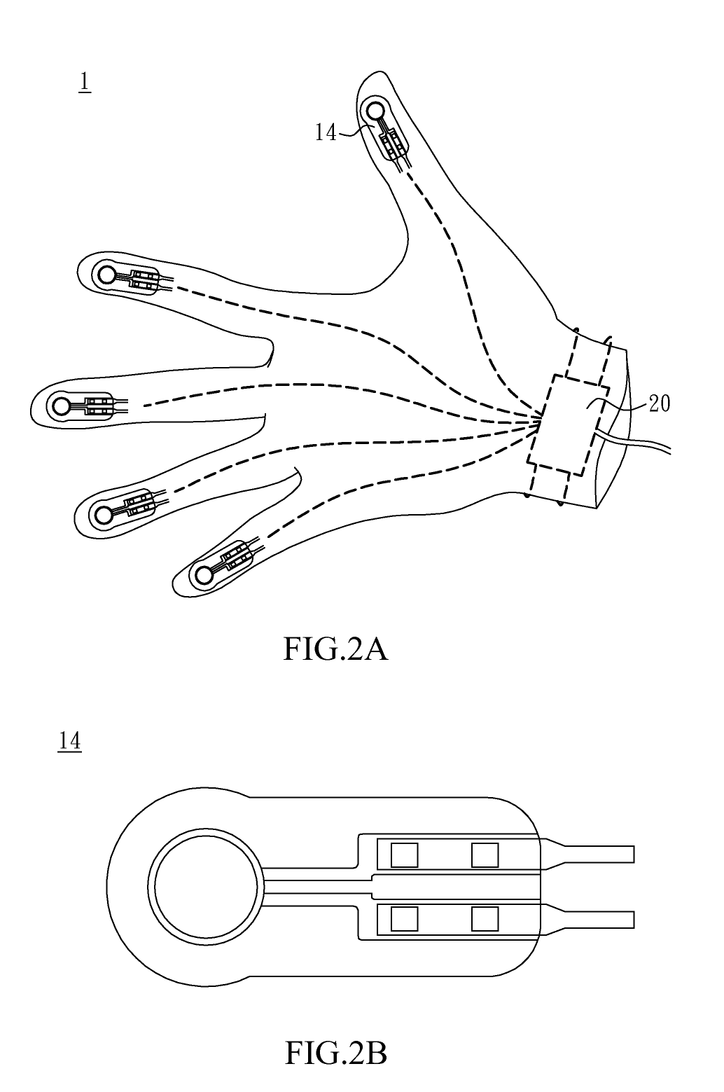

FIG. 2A and FIG. 2B show a glove with pressure sensors and a pressure sensor respectively according embodiments of the invention. Each finger of the glove 1 has a pressure sensor 14 on its contact surface. The microprocessor 10, the accelerometer 12, the pressure sensors 14, the gyro sensor 16 and the power source 18 are configured to be located on a control module 20 of the glove 1 or other suitable location. The status light 13, the input/output interface 15, the switch 17 and the mode switch 19 can also be configured to be located on a control module 20 of the glove 1 or other suitable location.

The pressure sensor 14 comprises a flexible thin film resistor or a pressure sensitive sensor. The force applied upon the pressure sensor 14 is obtained via calculating the voltage difference across two terminals of the pressure sensor 14. The voltage difference across two terminals of the pressure sensor 14 results from the resistance variation caused by the force applied upon the pressure sensor 14. Thus downward forces of fingers wearing the glove 1 with the pressure sensors 14 can be detected. More particularly, the glove 1 with the pressure sensors 14 can be used to detect motions and forces of user's palm and fingers. The pressure sensors 14 of the glove 1 detect pressing motions and forces of user's fingers and generate pressure value signals. The pressure value signals are transmitted to the microprocessor 10 and are processed via the microprocessor 10. The processed pressure value signals are then transmitted to a tablet computer, a smart phone or a personal computer, etc. via the input/output interface 15, for further application.

The accelerometer 12 and the gyro sensor 16 of the glove 1 with the pressure sensors 14 are used to detect angle, posture, motion and acceleration of user's palm. The accelerometer 12 detects an acceleration of the glove 1 with the pressure sensors 14 and generates an acceleration signal and then transmits the acceleration signal to the microprocessor 10. The gyro sensor 16 detects angle, posture, motion of the glove 1 with the pressure sensors 14 and generates a posture signal and then transmits the posture signal to the microprocessor 10. The accelerometer 12 and the gyro sensor 16 comprise a micro electro mechanical system accelerometer (MEMS) and a micro electro mechanical system gyro sensor. The acceleration signal and the posture signal generated by the accelerometer 12 and the gyro sensor 16 and transmitted to the microprocessor 10 are then processed by the microprocessor 10. The processed acceleration signal and posture signal are transmitted to a tablet computer, a smart phone or a personal computer, etc. via the input/output interface 15, for further application.

The power source 18 provides the glove 1 with the pressure sensors 14 with a necessary power for operation. The power source 18 is turned on/off via the switch 17. The power source 18 comprises a battery. The status light 13 shows a status of the glove 1 with the pressure sensors 14, such as statuses of power on or power off. The mode switch 19 is used to select between different use modes of the glove 1 with the pressure sensors 14 such as different use modes of playing a piano. The application or use modes of the glove 1 with the pressure sensors 14 can be selected through application programs of a tablet computer, a smart phone or a personal computer.

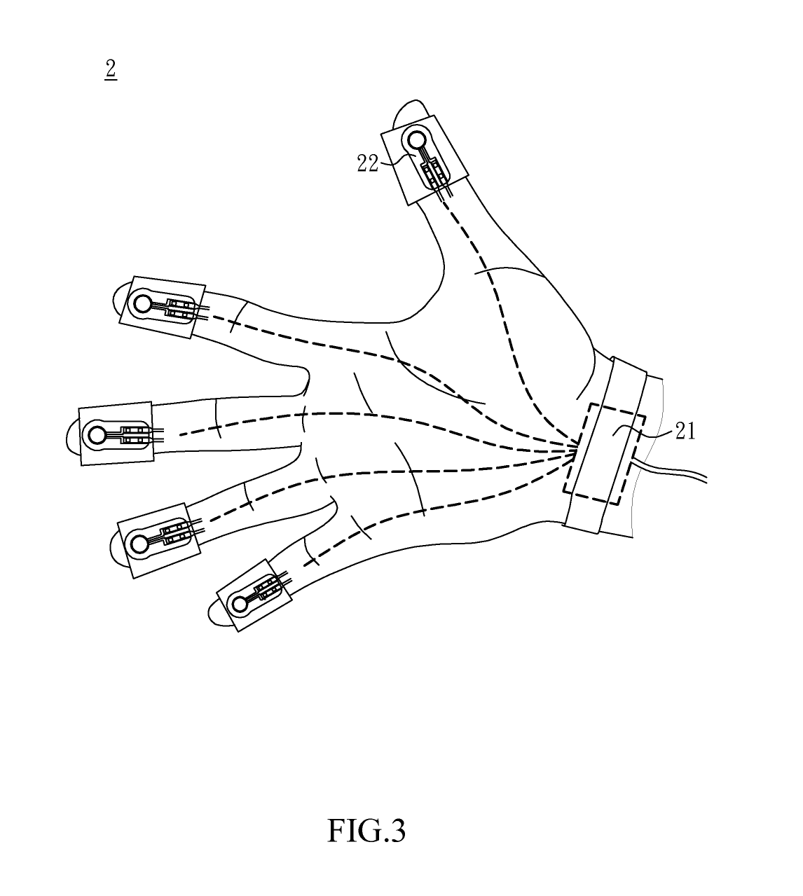

FIG. 3 shows a finger ring apparatus with pressure sensors according embodiments of the invention. In the embodiment set forth, gloves are used as a platform for the microprocessor 10, the accelerometer 12, the pressure sensors 14, the gyro sensor 16 and the power source 18, while the finger ring apparatus in FIG. 3 uses finger rings and a wristband as platforms. As shown in FIG. 3, the finger ring apparatus 2 comprises a wristband 21 and a plurality of finger rings 22. In one embodiment, each finger ring of the finger ring apparatus 2 has a pressure sensor 14 on its contact surface. The microprocessor 10, the accelerometer 12, the pressure sensors 14, the gyro sensor 16 and the power source 18 are configured to be located on the wristband 21. The finger ring apparatus 2 further comprises the status light 13, the input/output interface 15, the switch 17 and the mode switch 19 on the wristband 21.

The invention utilizes pressure sensors, an accelerometer and a gyro sensor so that electronic gloves and a finger ring apparatus can detect forces of user's fingers upon contact surfaces and angles, postures and motions of user's palms and then transmit corresponding signals to a tablet computer, a smart phone or a personal computer, etc. via the input/output interface 15. By using suitable application programs, a variety of applications for various simulations can be performed.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A pair of gloves with pressure sensors, comprising:
a microprocessor;
an accelerometer, the accelerometer detecting accelerations of the gloves and generating acceleration signals and then transmitting the acceleration signals to the microprocessor;
a plurality of pressure sensors, each the pressure sensor being configured to be located on a contact surface of each finger of the gloves to detect forces applied upon the contact surface of each the finger and to generate pressure value signals and transmit the pressure value signals to the microprocessor;
a gyro sensor, the gyro sensor detecting angles, postures and motions of the gloves to generate posture signals and transmit the posture signals to the microprocessor; and
a power source for providing the gloves with a power.

2. The gloves with pressure sensors of claim 1, wherein the accelerometer comprises a micro electro mechanical system accelerometer.

3. The gloves with pressure sensors of claim 1, wherein the gyro sensor comprises a micro electro mechanical system gyro sensor.

4. The gloves with pressure sensors of claim 1, wherein the pressure sensor comprises a flexible thin film resistor or a pressure sensitive sensor.

5. The gloves with pressure sensors of claim 1 further comprising a status light showing statuses of power on or power off of the gloves.

6. The gloves with pressure sensors of claim 1 further comprising a mode switch used to select between different use modes of the gloves.

7. The gloves with pressure sensors of claim 1 further comprising an input/output interface for connecting a tablet computer, a smart phone or a personal computer.

8. The gloves with pressure sensors of claim 1, wherein the power source comprises a battery.

9. A finger ring apparatus with pressure sensors, comprising:
a wristband, comprising:
a microprocessor;
an accelerometer, the accelerometer detecting accelerations of the finger ring apparatus and generating acceleration signals and then transmitting the acceleration signals to the microprocessor;
a gyro sensor, the gyro sensor detecting angles, postures and motions of the finger ring apparatus to generate posture signals and transmit the posture signals to the microprocessor; and
a power source for providing the finger ring apparatus with a power; and
a plurality of finger rings, each finger ring having a pressure sensor on a contact surface thereof to detect forces applied upon the contact surface and to generate pressure value signals and transmit the pressure value signals to the microprocessor.

10. The finger ring apparatus with pressure sensors of claim 9, wherein the pressure sensor comprises a flexible thin film resistor or a pressure sensitive sensor.

11. The finger ring apparatus with pressure sensors of claim 9, wherein the accelerometer comprises a micro electro mechanical system accelerometer.

12. The finger ring apparatus with pressure sensors of claim 9, wherein the gyro sensor comprises a micro electro mechanical system gyro sensor.

13. The finger ring apparatus with pressure sensors of claim 9 further comprising an input/output interface for connecting a tablet computer, a smart phone or a personal computer.

14. The finger ring apparatus with pressure sensors of claim 9 further comprising a status light showing statuses of power on or power off of the gloves.

15. The finger ring apparatus with pressure sensors of claim 9 further comprising a mode switch used to select between different use modes of the gloves.

16. The finger ring apparatus with pressure sensors of claim 9, wherein the power source comprises a battery.
